(19) United States
(12) Patent Application Publication
(10) Pub. No.: US 2011/0221192 A1
(43) Pub. Date: Sep. 15, 2011

(54) GENERATOR FOR GENERATING ELETRICAL ENERGY FROM MECHANICAL VIBRATIONS, AND METHOD FOR ADJUSTING THE RESONANT FREQUENCY OF SUCH A GENERATOR

(75) Inventors: Jens Makuth, Feucht (DE); Jan Mehner, Neukirchen (DE); Dirk Scheibner, Nurnberg (DE)

(73) Assignee: SIEMENS AKTIENGESELLSCHAFT, MUNICH (DE)

(21) Appl. No.: 12/998,520

(22) PCT Filed: Dec. 9, 2008
(86) PCT No.: PCT/EP2008/010583

§ 371 Date: Apr. 28, 2011

(51) Int. Cl. F03G 7/08; H02K 35/00

(52) U.S. Cl. 290/7; 310/17

(57) ABSTRACT

A universally and flexibly applicable generator generates electrical energy from mechanical vibrations. The generator includes a mechanically vibrating system having a spring system and device for changing the mechanical tension of the spring system. A method for adjusting the resonant frequency of the generator allows electrical energy to be generated from mechanical vibrations.

### CROSS REFERENCE TO RELATED APPLICATIONS

This application is based on and hereby claims priority to International Application No. PCT/EP2008/010583 filed on Dec. 9, 2008, the contents of which are hereby incorporated by reference.

### BACKGROUND

Autonomous sensors, networked where necessary, are increasingly widely used. Autonomous in this case means that corresponding sensors are usually embodied both for wireless communication and also for wireless energy supply. While wireless radio technologies have now achieved a high level of technical maturity, typically allowing their use even in an industrial systems environment, i.e. in the area of industrial automation for example, this is not yet correspondingly the case in relation to a wireless or cable-free energy supply. There is however basically the option of using batteries for the purposes of wireless energy supply. However, because of the restricted lifetime of batteries and the necessary maintenance effort when changing the batteries, this approach is associated with significant drawbacks in many cases.

Both in conjunction with sensors or sensor networks respectively and also for various other technical devices and applications which are dependent on self-sufficiency in energy supply, it can thus be expedient or necessary to obtain the electrical energy needed from the environment. Obtaining energy from the environment in such a way is also known by the term energy harvesting, particularly in conjunction with comparatively small devices to be supplied with electrical energy.

A generator can generate electrical energy from mechanical vibrations, with the generator featuring a mechanically vibrating system with a spring system.

Such a generator is known for example from the technical article Sensors and Actuators A 110 (2004) 344-349 “An electromagnetic vibration-powered generator for intelligent sensor systems”, P. Glynne-Jones, M. J. Tudor, S. P. Beepy, N. M. White. In this generator a mechanically vibrating system serves to capture the mechanical vibrations, i.e. acts as a vibration pickup. As well as the use of an electrodynamic converter principle known from the publication, also known from the technical articles published in proceedings XX Eurosensors 2006 “A new approach of a MEMS power generator based on a piezoelectric diaphragm”, I. Kühne, G. Eckstein, H. Seidel and “Power MEMS—A capacitive vibration-to-electrical energy converter with built-in voltage”, I. Kühne, A. Frey, G. Eckstein, H. Seidel, are generators for generating electrical energy from mechanical vibrations using a piezoelectric or a capacitive converter principle respectively.

Generators of the type mentioned above usually use an overincrease in the resonance of the generator to increase the energy yield, i.e. for optimizing the efficiency of the energy generation or conversion respectively. However the disadvantage of such generators is that the mechanically vibrating system of the generator has to be designed for a specific resonant frequency during manufacturing, so that resonant operation in each case requires advance knowledge of the frequencies occurring during the subsequent use of the generator or the frequency spectrum of the mechanical vibrations occurring. The use of a generator in resonant operation is in practice in many cases prevented or at least rendered significantly more difficult and more expensive by this restriction.

### SUMMARY

One possible object is to specify an especially efficient and at the same time universally and flexibly usable generator for generating electrical energy from mechanical vibrations, with the generator comprising a mechanically vibrating system with a spring system.

The inventors propose a generator to generate electrical energy from mechanical vibrations, with the generator having a mechanically vibrating system with a spring system. The proposed generator also includes a mechanism for altering the mechanical tension of the spring system.

The proposed generator is advantageous since it has an integrated option for resonance tuning. Thus the mechanism for altering the mechanical tension of the spring system make it possible to change the resonant frequency of the vibrating system or of the generator respectively. In such cases the proposal makes use of the fact that the resonant frequency of a vibrating system is generally determined by the ratio of spring stiffness and mass of the system. Advantageously in this case an alteration of the mechanical tension of the spring system of the generator or vibration converter can thus bring about an alteration of the spring constant and thus also of the resonant frequency of the vibrating system. This effect, which is also referred to by the term stress-stiffening effect, is comparable to tuning a guitar string and is based on the fact that tension or compression forces respectively in the spring system of the mechanically vibrating system bring about an increase or decrease respectively of the spring constant.

The fact that the generator has mechanism for altering the mechanical tension of the spring system means that the generator is in a position to adjust itself to a suitable operating frequency during the course of operation. Since the generator thus does not need to be adapted constructively to the circumstances of the respective application, this means that it is advantageously universally and flexibly applicable. This is especially of significance in the case of a generator manufactured or embodied as a micromechanical generator since the costs for adapting the structure are very high here by comparison with generators manufactured in precision technology.

The generator advantageously further offers the opportunity of adapting a generator during operation at any time to changing operating conditions. Over and above this the generator is advantageously embodied for alteration of the mechanical tension of the spring system without manual intervention being necessary to do this. This is especially of importance in the event of the generator being used in difficult-to-reach or hard-to-access locations or where manual intervention is not practicable, because of a high number of generators used for example.

In an especially preferred embodiment the generator is designed such that the generator, by altering the mechanical tension of the spring system, is embodied for automatic adaptation of the resonant frequency of the vibrating system to the frequency spectrum of the mechanical vibrations. This offers the advantage that, depending on the respective frequency spectrum of the mechanical vibrations, operation of the generator with maximum efficiency, i.e. maximum energy yields, is made possible automatically in each case. In this case the frequency spectrum of the mechanical vibrations can basically involve a specific frequency; as a rule the frequency spectrum will have a certain width however, i.e. mechanical vibrations exhibit different frequencies.

In a further especially preferred form of embodiment the generator has a radio interface and is embodied for automatically adapting the resonant frequency of the vibrating system to the frequency spectrum of the mechanical vibrations in response to a radio command received. This is advantageous since an activation or an initiation of an adaptation process of the resonant frequency of the vibrating system to the frequency spectrum of the mechanical vibrations on the part of a central control device is made possible.

In a further preferred embodiment of the generator the mechanism for altering the mechanical tension of the spring system is embodied such that the change in the mechanical tension of the spring system is effected by a mechanism which is self-retaining in a state of rest. In this case, a state of rest is designated within the framework of this discussion as a state in which the mechanical tension of the spring system is kept constant. Thus the generator, in accordance with the preferred development, only needs energy for altering the mechanical tension of the spring system, not however for maintaining a tension of the spring system once set. This has the advantage that the generator in normal operation does not need any additional energy, so that the electrical energy generated from the mechanical vibrations can be provided fully for the respective application and is not needed entirely or partly for the operation of the generator itself.

A corresponding self-retaining mechanism can for example include latching facilities of different types and designs. The generator is thus in a preferred form of embodiment characterized such that the mechanism for altering the mechanical tension of the spring system includes a toothed bar as well as a pawl system, with the movement of the toothed bar bringing about an alteration of the mechanical tensioning of the spring system and the toothed bar being held in its position in the state of rest by at least one pawl of the pawl system. A corresponding system comprising a toothed bar and also a pawl system involves an especially robust and simple form of embodiment of a self-retaining mechanism bringing about the change in the mechanical tension of the spring system.

Within the framework of the previously described preferred development the generator is advantageously embodied such that the pawl system for moving the toothed bar features at least one further pawl. An especially simple mechanism which is self retaining in the state of rest is realized by this for altering the mechanical tension of the spring system.

Advantageously the generator can be embodied in this case such that the pawl system is driven electrostatically electromagnetically or piezo-actuatably. This is advantageous since electrostatic, electromagnetic and piezo-actuatable drives can be manufactured at comparatively low cost and are especially able to be realized for low power requirements.

Advantageously the generator can also be developed such that the mechanism for altering the mechanical tension of the spring system includes a toothed bar as well as a motor connected by self-inhibiting transmission to the toothed bar, with the motor being embodied the moving the toothed bar and a movement of the toothed bar effecting an alteration of the mechanical tension of the spring system. This involves an alternate, likewise comparatively robust and simple realization of a mechanism which is self-retaining in a state of rest for altering the mechanical tension of the spring system.

Preferably the generator is developed such that the mechanism for altering the mechanical tension of the spring system features a lever mechanism for increasing the change in the mechanical tension of the spring system brought about by a movement of the toothed bar. Depending on the respective circumstances, a corresponding lever mechanism is advantageous because of the increase achieved in the mechanical tension of the spring system brought about by the movement of the toothed bar.

Basically the generator can be manufactured or designed in a different manner. Advantageously the generator in such cases is on the one hand manufactured at low cost, whereby on the other hand in particular a size of generator which is the smallest possible is desirable since this opens up numerous application options. In an especially preferred form of embodiment the generator is embodied micromechanically. Such a micromechanical embodiment, in the form of a so-called micro-electro-mechanical system (MEMS) for example, is especially advantageous because of the comparatively low manufacturing costs as well as the miniaturization that this makes possible. As an alternative to this the generator can however advantageously also be embodied using precision mechanics.

In a further especially preferred form of embodiment the generator is embodied for generating electrical energy from mechanical vibrations using an electrodynamic, a piezoelectric or a capacitive converter principle. This is advantageous since the principles are proven as such and thus the corresponding generators are comparatively low-cost to manufacture as well as comparatively efficient in their operation.

The inventors also propose a method for adjusting the resonant frequency of a generator for generating electrical energy from mechanical vibrations.

The proposed method adjusts the resonant frequency of a generator for generating electrical energy from mechanical vibrations which allows a flexible adaptation of the resonant frequency of the generator to the frequency spectrum of the respective mechanical vibrations.

The proposed method adjusts the resonant frequency of a generator for generating electrical energy from mechanical vibrations, whereby within a tuning range the resonant frequency of a mechanically vibrating system, the generator is altered by altering the mechanical tension of a spring system of the mechanically vibrating system, the value of the resonant frequency of the mechanically vibrating system is determined in which the generator operates at maximum efficiency and the resonant frequency of the mechanically vibrating system is adjusted to the frequency determined.

The advantages of the method essentially correspond to the advantages stated previously in conjunction with the generator or the developments of the generator respectively, so that the reader is referred in this context to previous remarks. The same applies in relation to the preferred developments of the method given below as regards the corresponding preferred developments of the generator.

In an especially preferred embodiment the method is designed so that the alteration of the mechanical tension of the spring system is brought about by a mechanism which is self-retaining in a state of rest.

Preferably the method can also execute such that a radio command is received by the generator and the resonant frequency of the generator is adjusted in response to said command.

### BRIEF DESCRIPTION OF THE DRAWINGS

These and other objects and advantages of the present invention will become more apparent and more readily appreciated from the following description of the preferred embodiments, taken in conjunction with the accompanying drawings of which:

FIG. 1 shows a schematic of a first exemplary embodiment of a proposed generator with mechanism for altering the mechanical tension of a spring system of a mechanically vibrating system of the generator,

FIG. 2 shows an extract from a second exemplary embodiment of the generator with a pawl system having mechanism for altering the mechanical tension of the spring system,

FIG. 3 shows an extract from a third exemplary embodiment of the generator with a pawl system having mechanism for altering the mechanical tension of the spring system,

FIG. 4 shows an extract from a fourth exemplary embodiment of the generator with a motor as well as a self-inhibiting transmission featuring mechanism for altering the mechanical tension of the spring system,

FIG. 5 shows an extract from a fifth exemplary embodiment of the generator with a motor, a self-inhibiting transmission and also a lever mechanism featuring mechanism for altering the mechanical tension of the spring system and

FIG. 6 shows a frequency spectrum of mechanical vibrations to explain an exemplary embodiment of a proposed method.

### DETAILED DESCRIPTION OF THE PREFERRED EMBODIMENT

Reference will now be made in detail to the preferred embodiments of the present invention, examples of which are illustrated in the accompanying drawings, wherein like reference numerals refer to like elements throughout.

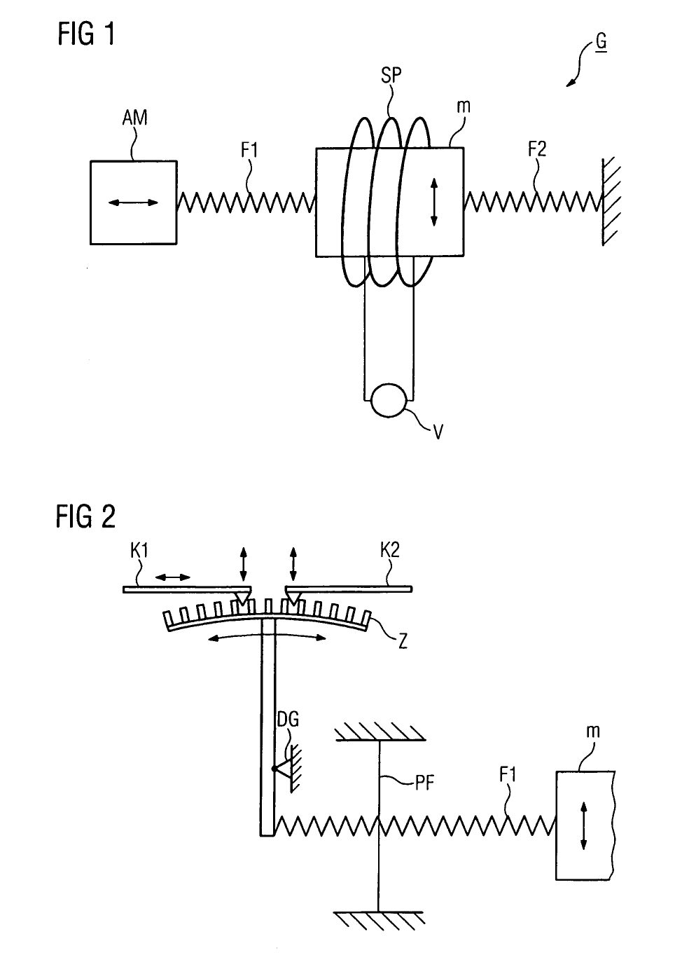

FIG. 1 shows in a schematic sketch a first exemplary embodiment of the proposed generator with mechanism for altering the mechanical tension of a spring system of a mechanically vibrating system of the generator. Shown in this figure is the principal structure of a generator G for generating electrical energy from mechanical vibrations, with the operating frequency of the generator G able to be altered, especially adapted, to the spectrum of the mechanical vibrations present in each case.

In detail the generator G has a mechanically vibrating system with a spring system including the springs F1 and F2. The springs F1, F2 serve to capture the mechanical vibrations acting on a mass m of the mechanically vibrating system, with the mechanical energy of the vibrations being converted into electrical energy using an electrodynamic converter principle by a coil SP wound over the mass m. In this case the mechanical vibrations in the exemplary embodiment depicted in FIG. 1 bring about a movement or vibration respectively of the mass m, which can also be referred to as a seismic mass, in a vertical direction. An alternating current induced by this in the coil SP can be used or tapped off respectively by a load V.

In accordance with the diagram in FIG. 1 the spring system ends on the spring side F1 at a tension system or mechanism AM for altering the mechanical tension of the spring system, through which, as is indicated in FIG. 1 by a corresponding double headed arrow, normal forces can be generated in the springs F1, F2 in the horizontal direction, which through the stress-stiffening effect bring about an alteration of the mechanical tension of the spring system and thereby a change in the spring constant of the vibrating system including the spring system as well as the mass m. Through the mechanism AM for altering the mechanical tension of the spring system it is thus advantageously made possible to adapt the operating frequency or resonant frequency of the generator G to the respective frequency spectrum of the mechanical vibrations present.

It should be pointed out that as an alternative to the electromagnetic converter principle shown by way of example in FIG. 1, other converter principles can also be used, so that the generator G for example is also able to be realized in a corresponding manner using a capacitive or piezoelectric converter principle. The decisive factor here is merely that the generator G is embodied independently of the converter principle used for altering the mechanical tension of the spring system.

FIG. 2 shows a second exemplary embodiment of the generator with a pawl system featuring mechanism for altering the mechanical tension of the spring system. In such cases the components shown can involve the mechanism AM shown in FIG. 1 for altering the mechanical tension of the spring system.

In accordance with the diagram shown in FIG. 2 the mass m is connected by the spring F1 which is guided by a parallel guide PF to a toothed bar Z having an articulated joint DG. The toothed bar Z in this case is moved by a pawl system, with a first pawl K1 in the form of a switching pawl realizing the advance while a second pawl K2 in the form of a locking pawl holds the toothed bar Z in its respective position. The pawls K1, K2 can for example be driven electrostatically, electromagnetically, i.e. in accordance with the principle of a relay, or also piezo-actuatably. Since the pawls K1, K2 engage with each other in the rest position and hold the toothed bar Z in its position, the mechanism for altering the mechanical tension of the spring system, i.e. for resonance tuning, exclusively requires energy for altering the mechanical tension of the spring system. In the state of rest on the other hand, i.e. to maintain a tension once it has been set, no energy is needed.

A movement of the toothed bar Z causes a tension or compression movements respectively via the articulated joint DG in the spring F1 of the vibrating system and thus leads to an alteration of the mechanical tension of the spring system of the generator. This results, in accordance with the explanations above, in the resonant frequency of the mechanically vibrating system being influenced, i.e. altered.

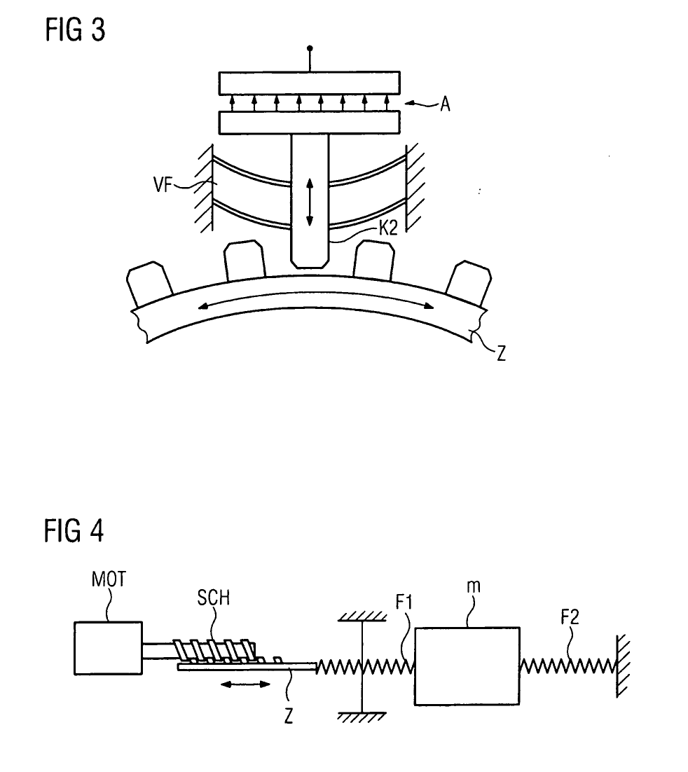

FIG. 3 shows an extract from a third exemplary embodiment of the generator with a pawl system featuring mechanism for altering the mechanical tension of the spring system. Shown in this figure is a detailed possible realization of the mechanism shown in FIG. 2 for altering the mechanical tension of the spring system of the generator. In this case the pawl K2 is located in accordance with the diagram in FIG. 3, as a result of pretensioned springs VF in the rest state permanently engaged with the teeth of the toothed bar Z. To adjust the toothed bar Z, i.e. to alter the mechanical tension of the spring system of the generator, the pawl K2 is pulled via an external force which is effected by an electrostatic drive A.

In accordance with the description in conjunction with FIG. 2, other embodiments of the drive are conceivable as an alternative however.

FIG. 4 shows an extract from the fourth exemplary embodiment of the generator with a motor and also a self-inhibiting transmission featuring mechanism for altering the mechanical tension of the spring system. Shown in the figure are mechanism for altering the mechanical tension of the spring system which, unlike the mechanism shown in FIG. 2, use a micromotor MOT with a self-inhibiting transmission and a toothed bar in order to realize a tensile force in the spring system F1, F2 of the vibrating system. The self-inhibiting transmission features a worm gear SCH, which in the state of rest interacts with the toothed bar Z such that the tensile state present or the existing tension of the spring system respectively is retained without supplying energy. A realization in accordance with the diagram shown in FIG. 4 is especially suitable in the case of a precision-mechanical embodiment of the generator G.

FIG. 5 shows an extract from a fifth exemplary embodiment of the generator with a motor, a self-inhibiting transmission as well as a lever mechanism featuring mechanism for altering the mechanical tension of the spring system. In this figure the mechanism shown for altering the mechanical tension of the spring system F1, F2 substantially correspond to those depicted in FIG. 4, with a lever mechanism additionally being provided for increasing the force effect which comprises a lever H as well as a lever joint HG. This advantageously makes it possible to adapt the alteration of the mechanical tension of the spring system F1, F2 brought about by the movement of the toothed bar Z to the respective requirements or circumstances.

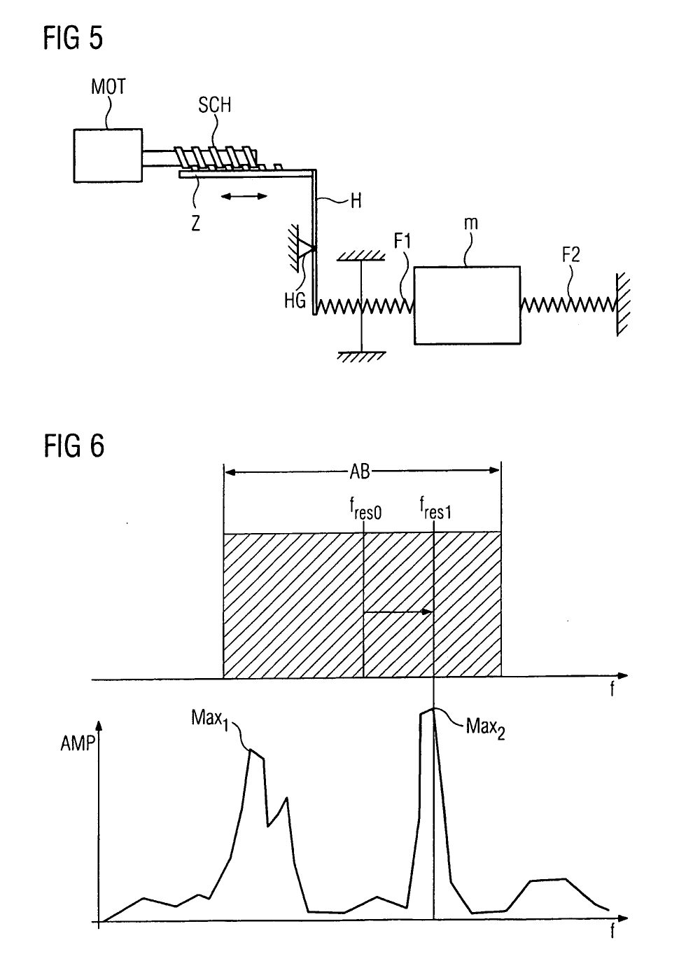

FIG. 6 shows a frequency spectrum of mechanical vibrations to illustrate an exemplary embodiment of the method. Shown in this figure is the amplitude of the mechanical vibrations AMP as a function of their frequency f. The adjusting of the resonant frequency of a generator for generating electrical energy from mechanical vibrations can only be undertaken such that, within a tuning range AB, the resonant frequency of a mechanically vibrating system of the generator is altered by an alteration of the mechanical tension of a spring system of the mechanically vibrating system. This means that the generator or energy converter respectively has a tuning range AB in which it tunes its resonant frequency by an integrated tuning mechanism independently or automatically. In such cases the frequency with the maximum energy yield is determined, i.e. that frequency at which the generator operates with maximum efficiency. In the exemplary embodiment of FIG. 6 in this case the resonant frequency of the generator is shifted as a result of the untuned frequency fᵣₑₛ0 by the tuning mechanism to the tuned frequency fᵣₑₛ1 and subsequently held there for the further operation of the generator by the maintenance of the corresponding mechanical tension of the spring system of the generator. The tuning method is controlled advantageously by a control device of the generator, which can be embodied in the form of a microprocessor for example.

In accordance with the exemplary embodiments described above the generator and also the method especially offer the advantage of making it possible to flexibly adapt the operating or resonant frequency of the generator or of the vibrating system of the generator respectively to the mechanical vibrations obtaining in each case. The energy yields of the generator are maximized by this without manual intervention being required for this purpose. This makes it possible to employ a corresponding generator universally for different applications, whereby the manufacturing costs for such a generator reduce significantly as a result of the increase in the numbers produced. The alteration of the mechanical tension of the spring system of the generator can advantageously be bought about by a mechanism which is self-retaining in a state of rest, so that in normal operation of the generator no energy is needed to maintain a mechanical tension of the spring system once adjusted.

The invention has been described in detail with particular reference to preferred embodiments thereof and examples, but it will be understood that variations and modifications can be effected within the spirit and scope of the invention covered by the claims which may include the phrase “at least one of A, B and C” as an alternative expression that means one or more of A, B and C may be used, contrary to the holding in Superguide v. DIRECTV, 69 USPQ2d 1865 (Fed. Cir. 2004).

1-15. (canceled)

16. A generator for generating electrical energy from mechanical vibrations, comprising:
a mass;
at least one spring supporting the mass with a mechanical tension so as to allow the mass to vibrate, the mass and at least one spring forming a spring system;
a mechanical-electrical transducer to convert mechanical vibrations of the mass into electrical energy; and
a variable tensioner to change the mechanical tension of the spring system.

17. The generator as claimed in claim 16, wherein
the variable tensioner automatically adapts the mechanical tension of the spring system to the frequency spectrum of the mechanical vibrations.

18. The generator as claimed in claim 17, wherein
the generator further comprises a radio receiver for communication over a radio interface,
the spring system has a resonant frequency, and
the variable tensioner automatically adapts the resonant frequency of the spring system to a frequency spectrum of the mechanical vibrations in response to a radio command received by the radio receiver.

19. The generator as claimed in claim 16, wherein
the variable tensioner includes a mechanism to maintain a constant mechanical tension without energy input, when the mechanical tension is not being changed.

20. The generator as claimed in claim 19, wherein
the variable tensioner comprises a toothed bar and a pawl system, with a movement of the toothed bar changing the mechanical tension of the spring system, and
when at rest, the toothed bar is held in position by at least one pawl of the pawl system.

21. The generator as claimed in claim 20, wherein
the pawl system comprises a first pawl to hold the toothed bar in position and a second pawl to move the toothed bar.

22. The generator as claimed in claim 20, wherein
the pawl system is driven electrostatically, electromagnetically or piezo-electrically.

23. The generator as claimed in claim 19, wherein
the variable tensioner comprises a toothed bar and a motor connected to the toothed bar by a self-inhibiting transmission such that the motor moves the toothed bar and a movement of the toothed bar changes the mechanical tension of the spring system.

24. The generator as claimed in claim 23, wherein
the variable tensioner further comprises a lever transmission such that a reduced toothed bar movement produces an increased change in the mechanical tension.

25. The generator as claimed in claim 16, wherein the generator is embodied as a micro-electromechanical system (MEMS).

26. The generator as claimed in claim 16, wherein the generator is embodied in precision mechanics.

27. The generator as claimed in claim 16, wherein
the mechanical-electrical transducer generates electrical energy from mechanical vibrations using an electrodynamic, a piezoelectric or a capacitive converter principle.

28. The generator as claimed in claim 16, wherein the mass is supported between two springs.

29. A method for adjusting a resonant frequency of a generator for generating electrical energy from mechanical vibrations, comprising:
determining a resonant frequency of a spring system in which a mass is supported by at least one spring with mechanical tension so as to allow the mass to vibrate;
determining a maximum efficiency resonant frequency for converting mechanical vibrations into electrical energy using the spring system; and
adjusting the resonant frequency of the spring system within a tuning range by altering the mechanical tension of the spring system, the resonant frequency of the spring system being adjusted to approximate the maximum efficiency resonant frequency.

30. The method as claimed in claim 29, wherein
the mechanical tension of the spring system is altered with a mechanism which maintains a constant mechanical tension without energy input, when the mechanical tension is not being changed.

31. The method as claimed in claim 29, further comprising:
receiving a radio command by the generator; and
adjusting the resonant frequency of the spring system in response to the radio command.
